(19) United States
(12) Patent Application Publication
(10) Pub. No.: US 2013/0162572 A1
(43) Pub. Date: Jun. 27, 2013

(54) TOUCH PANEL

(71) Applicant: LG Innotek Co., Ltd., Seoul (KR)

(72) Inventors: Myung Jae KWON, Seoul (KR); Sang Beum LEE, Seoul (KR)

(73) Assignee: LG INNOTEK CO., LTD., Seoul (KR)

(21) Appl. No.: 13/724,449

(22) Filed: Dec. 21, 2012

(30) Foreign Application Priority Data
Dec. 22, 2011 (KR) 10-2011-0139805

(51) Int. Cl. G06F 3/041

(52) U.S. Cl. CPC G06F 3/041
USPC 345/173

(57) ABSTRACT

Disclosed is a touch panel. The touch panel includes a transparent window; a printed pattern disposed under the transparent widow and spaced apart from the transparent window; and an intermediate layer between the transparent window and the printed pattern.

### CROSS-REFERENCE TO RELATED APPLICATION

This application claims the benefit under 35 U.S.C. §119 of Korean Patent Application No. 10-2011-0139805, filed Dec. 22, 2011, which is hereby incorporated by reference in its entirety.

### BACKGROUND

The embodiment relates to a printed pattern structure of a touch panel.

A touch panel is installed on a display surface of an image display device such as a cathode ray tube (CRT), a liquid crystal display (LCD), a field emission display (FED), a plasma display panel (PDP), and an electro-luminescence device (ELD), so that a user inputs predetermined information into a computer by pressing the touch panel while viewing the image display device.

FIGS. 1 and 2 are views showing main components of a capacitive type touch panel. FIG. 1 is a plan view showing a multi-layer bonding structure, and FIG. 2 is a sectional view taken along a line X of FIG. 1. Referring to FIGS. 1 and 2, the touch panel generally includes an upper optical clear adhesive (OCA) 50 provided under a transparent window 10, and an upper electrode layer (ITO) 40, a lower OCA 30, and a lower electrode layer 20 provided under the upper OCA 50. In addition, a liquid crystal panel 60 adheres to the bottom surface of the above structure. A touch screen panel TSP formed by bonding various layers to each other has a bonding area C which is formed by cutting the upper OCA 50, the upper electrode layer (ITO) 40, and the lower OCA 30 for the purpose of bonding to an FPCB module and exposes a connection pad P.

The above touch panel includes a printed pattern implemented to represent various colors depending on the design of a terminal or to hide internal wirings. The printed pattern needs to be directly printed on the bottom surface of the transparent window 10, to represent superior shielding characteristic, and to have no pin-hole, protrusion, and dent.

However, in the related art, since a printed pattern is formed on the transparent window 10 by performing printing works at least five times, an electrode wire, an insulating layer, or an electrode pattern is deformed or shorted due to step difference in printing works, or uniformity is degraded so that failure occurs.

### BRIEF SUMMARY

The embodiment provides a touch panel capable of reducing failure of an expensive transparent window to improve productivity by diminishing printing failure of a printed pattern by forming the printed pattern on an electrode layer of a touch panel, rather than the transparent window, and then bonding the printed pattern to the transparent window.

According to the embodiment, there is provided a touch panel including: a transparent window; a printed pattern disposed under the transparent widow and spaced apart from the transparent window; and an intermediate layer between the transparent window and the printed pattern.

The intermediate layer may include a sensing electrode pattern layer or an adhesive material layer.

The intermediate layer may include a plurality of sensing electrode pattern layers, and the printed pattern may be formed on the sensing electrode pattern layer which is not adjacent to the transparent window among the sensing electrode pattern layers.

The adhesive material layer may include a Pressure Sensitive Adhesive (PSA) or an Optical Clear Adhesive (OCA).

The sensing electrode pattern layer may be formed at both surfaces of an insulating layer.

The printed pattern may be disposed at a non-active region of the touch panel.

According to the embodiment, failure of the expensive transparent window is reduced to improve productivity by diminishing printing failure of a printed pattern by forming the printed pattern on an electrode layer of a touch panel, rather than the transparent window, and then bonding the printed pattern to the transparent window.

### BRIEF DESCRIPTION OF THE DRAWINGS

FIGS. 1 and 2 are views showing main components of a capacitive type touch panel.

FIG. 3 is a sectional view illustrating a touch panel according to a first embodiment.

FIG. 4 is a sectional view illustrating a touch panel according to a second embodiment.

FIG. 5 is a sectional view illustrating a touch panel according to a third embodiment.

FIG. 6 is a sectional view illustrating a touch panel according to a fourth embodiment.

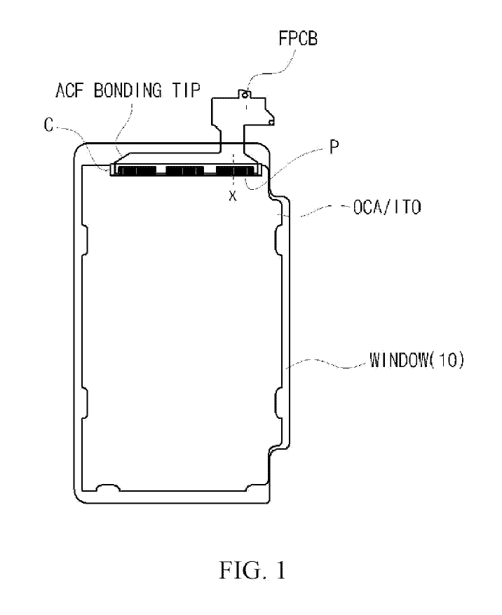

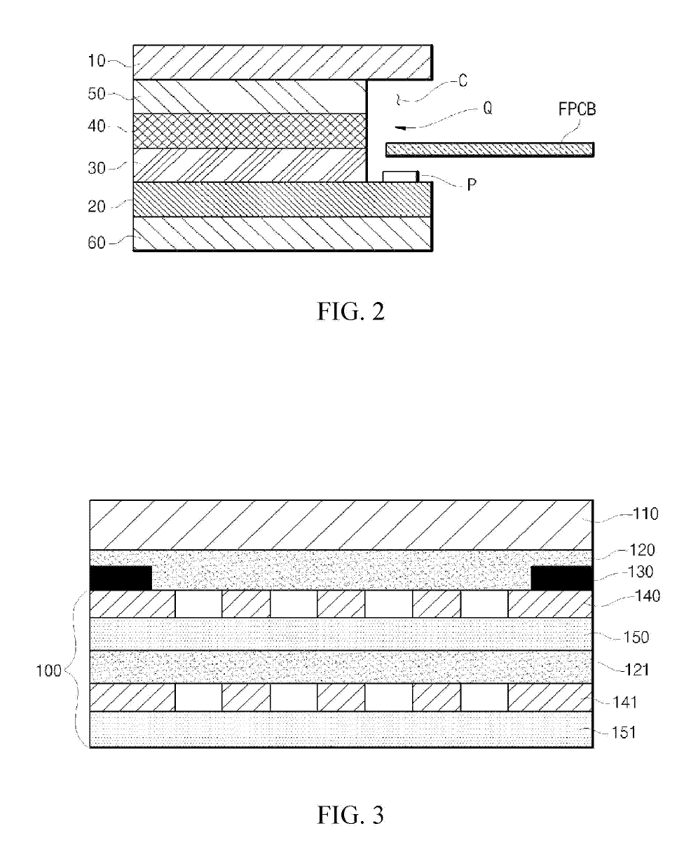

### DETAILED DESCRIPTION

Hereinafter, a touch panel according to an exemplary embodiment will be described with reference to the accompanying drawings in detail. Detailed descriptions of well-known functions and structures incorporated herein may be omitted when they make the subject matter rather unclear. The size of the elements shown in the drawings may be exaggerated for the purpose of explanation and may not utterly reflect the actual size.

FIG. 3 is a sectional view illustrating a touch panel according to a first embodiment. The touch panel according to a first embodiment is described with reference to FIG. 3.

Referring to FIG. 3, a protective substrate 110 is disposed at the uppermost portion of the touch panel. The protective substrate 110 may be a transparent window.

As shown in FIG. 3, an intermediate layer is formed at a lower portion of the transparent window 110. In the embodiment of FIG. 3, the intermediate layer is prepared as a first adhesive material layer 120. The first adhesive material layer 120 may be configured by a Pressure Sensitive Adhesive (PSA) or an OCA.

A first sensing electrode pattern layer 140 is formed at a lower portion of the first adhesive material layer 120 serving as the intermediate layer, and the printed pattern 130 is disposed on the sensing electrode pattern layer 140.

That is, the printed pattern 130 is formed at a side of the sensing electrode pattern portion 100, rather than a side of the transparent window 110. In detail, the printed pattern 130 is not formed on the side of the transparent window 110, but formed at the side of the touch panel 100 including the first sensing electrode pattern layer 140, a first PET substrate 150, a second adhesive material layer 121, a second sensing electrode pattern layer 141, and a second PET substrate 151, and the transparent windows 110 is bonded to the touch panel 100 by the first adhesive material layer 120.

The first sensing electrode pattern layer 140 is disposed on the first PET substrate 150, and the second sensing electrode pattern layer 141 is disposed on the second PET substrate 151. The second PET substrate 151 may be bonded to the first PET substrate 150 through the second adhesive material layer 121.

In the embodiment of FIG. 3, the printed pattern 130 is disposed on the first sensing electrode pattern layer 140.

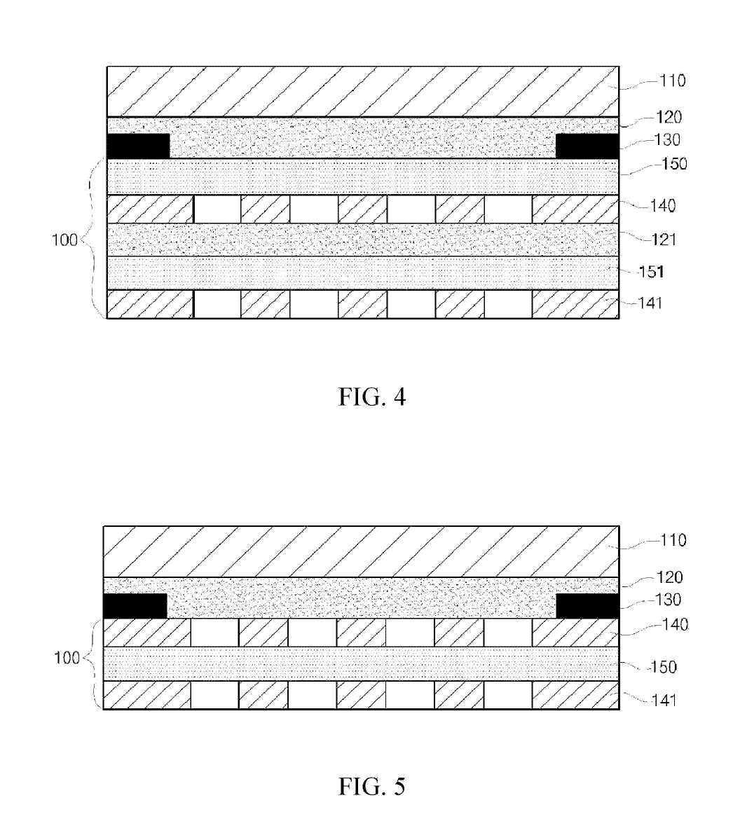

FIG. 4 is a sectional view illustrating a touch panel according to a second embodiment.

As shown in FIG. 4, an intermediate layer is formed at a lower portion of a transparent window 110. In the same manner as the embodiment of FIG. 3, the intermediate layer is prepared as the first adhesive material layer 120. The first adhesive material layer 120 may be configured by a Pressure Sensitive Adhesive (PSA) or an OCA.

The first PET substrate 150 is disposed at a lower portion of the first adhesive material layer 120 serving as the intermediate layer, the first sensing electrode pattern layer 140 is disposed at a lower portion of the first PET substrate 150, and the second adhesive material layer 121 is formed at a lower portion of the first sensing electrode pattern layer 140. The second PET substrate 151 and the second sensing electrode pattern layer 141 are sequentially formed under the second adhesive material layer 121 formed as described above.

That is, in the embodiment shown in FIG. 4, a formation order of respective layers of the touch panel is inversed to that of the embodiment shown in FIG. 3. However, similar to the embodiment of FIG. 3, the printed pattern 130 is formed at a side of the touch panel 100 other than a side of the transparent window 110, and a first sensing electrode pattern layer 140 of the touch panel 100 is bonded to the transparent window 110 through the first adhesive material layer 120.

In the embodiment of FIG. 4, the printed pattern 130 is disposed on the first PET substrate 150.

FIG. 5 is a sectional view illustrating a touch panel according to a third embodiment.

As shown in FIG. 5, an intermediate layer is formed at a lower portion of a transparent window 110. In the same manner as the embodiments of FIGS. 3 and 4, the intermediate layer is prepared as the first adhesive material layer 120. The first adhesive material layer 120 may be configured by a PSA or an OCA.

The sensing electrode pattern part 100 may be configured so that a first sensing electrode pattern layer 140 and a second sensing electrode pattern layer 141 are formed on a both surfaces of the PET substrate 150, respectively, and the printed pattern 130 is disposed at a side of the first sensing electrode pattern layer 140 of the touch panel 100.

That is, similar to the embodiments of FIGS. 3 and 4, the printed pattern 130 is formed at a side of the touch panel 100 other than a side of the transparent window 110, and a first sensing electrode pattern layer 140 of the touch panel 100 is bonded to the transparent window 110 through the first adhesive material layer 120 in the embodiment of FIG. 5.

In the embodiment of FIG. 5, the printed pattern 130 is disposed on the first sensing electrode pattern layer 140.

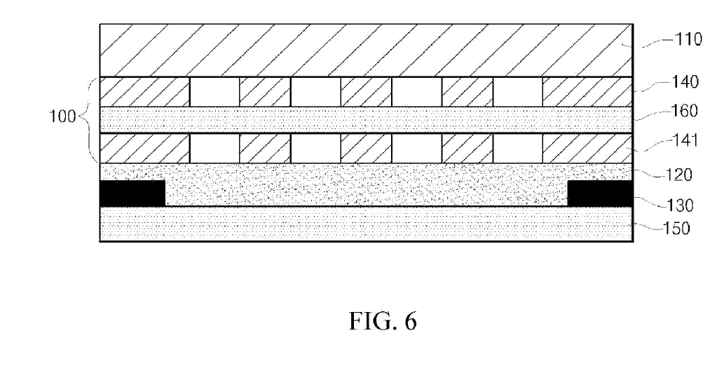

FIG. 6 is a sectional view illustrating a touch panel according to a fourth embodiment.

As shown in FIG. 6, an intermediate layer is formed at a lower portion of a transparent window 110. In this case, a touch panel layer is disposed as the intermediate layer in the embodiment of FIG. 6.

That is, the touch panel 100 includes a first sensing electrode pattern layer 140, an insulating layer 160, and a second sensing electrode pattern layer 140 and is bonded to a transparent window 110, a printed pattern 130 is disposed on a PET substrate 150, and the PET substrate 150 on which the printed pattern 130 is bonded to the sensing electrode pattern part 100 through an adhesive material layer 120.

That is, according to the embodiment of FIG. 6, the printed pattern 130 is disposed between the PET substrate 150 and the touch panel 100 including the first sensing electrode pattern layer 141 and the second sensing electrode pattern layer 140 other than on a transparent window 110.

That is, in the embodiment of FIG. 6, a printed pattern substrate 150 is further disposed at a lower portion of the transparent window 110, and the printed pattern 130 is disposed on the printed pattern substrate 150.

As mentioned above, according to the embodiments, printing failure of a printed pattern can be diminished by forming the printed pattern on an electrode layer of a touch panel, rather than the transparent window, and then bonding the printed pattern to the transparent window.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A touch panel comprising:
a transparent window;
a printed pattern disposed under the transparent widow and spaced apart from the transparent window; and
an intermediate layer between the transparent window and the printed pattern.

2. The touch panel of claim 1, wherein the intermediate layer comprises a sensing electrode pattern layer or an adhesive material layer.

3. The touch panel of claim 2, wherein the intermediate layer comprises a plurality of sensing electrode pattern layers, and the printed pattern is formed on the sensing electrode pattern layer which is not adjacent to the transparent window among the sensing electrode pattern layers.

4. The touch panel of claim 2, wherein the adhesive material layer comprises a Pressure Sensitive Adhesive (PSA) or an Optical Clear Adhesive (OCA).

5. The touch panel of claim 2, wherein the sensing electrode pattern layer is formed at both surfaces of an insulating layer.

6. The touch panel of claim 1, wherein the printed pattern is disposed at a non-active region of the touch panel.

7. A touch panel comprising:
a protective substrate;
a sensing electrode pattern layer disposed on the protective substrate to detect a location; and
a printed pattern spaced apart from the protective substrate.

8. The touch panel of claim 7, wherein an adhesive layer is disposed between the protective substrate and the printed pattern.

9. The touch panel of claim 8, wherein the adhesive layer comprises a Pressure Sensitive Adhesive (PSA) or an Optical Clear Adhesive (OCA).

10. The touch panel of claim 7, wherein the sensing electrode pattern layer comprises a sensing electrode substrate and a sensing electrode.

11. The touch panel of claim 10, wherein the printed pattern is disposed on the sensing electrode substrate.

12. The touch panel of claim 10, wherein the printed pattern is disposed on the sensing electrode.

13. The touch panel of claim 7, wherein the sensing electrode pattern layer is disposed between the protective substrate and the printed pattern.

14. The touch panel of claim 13, further comprising a printed pattern substrate on the protective substrate, wherein the printed pattern is disposed on the printed pattern substrate.
